(19) United States
(12) Patent Application Publication
(10) Pub. No.: US 2010/0064915 A1
(43) Pub. Date: Mar. 18, 2010

(54) GARMENT

(76) Inventors: Aristidis Skarpetis, Aigeira Ahaias (GR); Kathryn Anne Sanderson, Aigeira Ahaias (GR)

Correspondence Address: MERCHANT & GOULD PC, P.O. BOX 2903, MINNEAPOLIS, MN, 55402-0903, US

(21) Appl. No.: 12/516,485

(22) PCT Filed: Nov. 26, 2007
(86) PCT No.: PCT/EP07/10251

§ 371 Date: May 27, 2009

(30) Foreign Application Priority Data
Nov. 27, 2006 (GB) 0623609.5

(51) Int. Cl. B41M 1/12; B32B 38/00; A41D 1/00

(52) U.S. Cl. 101/129; 156/219; 2/69

(57) ABSTRACT

A garment, a region of which has on a first side a design for coloring-in, the region of the garment having on the reverse side thereof a removable backing to hold the material of the garment in place while coloring-in is carried out. The removable backing has a material that can be folded without creasing.

The present invention relates to a garment, and in particular a garment having a design for colouring-in.

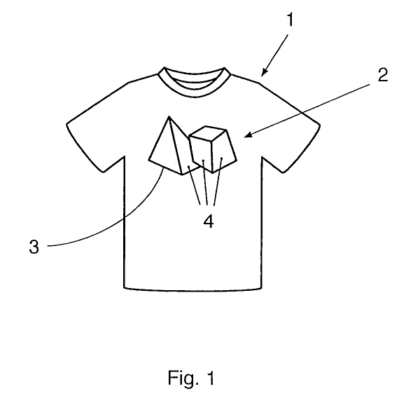

Garments comprising a design for colouring-in are known in the art; an example of such a garment is shown in FIG. 1. The garment, a T-shirt 1, comprises a design 2 consisting of an outline 3 defining a number of areas 4. The design 2 is intended to be coloured in by a user, for example a child, using felt-tip colouring pens to fill the defined areas 4. Other methods of colouring-in could be used, for example crayons or marker pens.

A disadvantage of the garment 1 is that while it is being coloured in it needs to be held in place, which as it lacks stiffness is difficult. Also, even if held in place, the material of the garment in the area being coloured in (for example under the tip of a pen) will shift and stretch with respect to the surrounding material. This hinders the process of colouring-in, and may cause the resultant colouring to be uneven, or go outside the lines surrounding the areas.

One solution is for the user to hold the material of the garment in place with their free hand. However, this may become uncomfortable, especially if the design to be coloured in is large. For children, due to the size and strength of their hands, holding the material in place with their free hand may be impossible. This will also be the case for other users with limited hand strength, for example the elderly. Another solution is for the garment to be placed over a drum, and held in place using a hoop that is tightened around the perimeter of the drum. Such a drum is similar to an embroidery hoop, except that the inside drum is not a ring but rather has a surface upon which the material of the garment rests. A disadvantage of such drums is that although the material in the area of the garment that is to be coloured in is held in place, the fabric is still able to shift and stretch with respect to the surrounding material. Another disadvantage is that only a small area of material can be held in place at any one time, so large areas cannot be coloured in without changing the area held by the drum. Another disadvantage is that such drums are relatively expensive and bulky. They therefore would not for example be particularly suitable for including as part of a “T-shirt colouring-in” kit, as they would greatly increase cost and size of the kit.

Another solution, as shown in GB 2277485 A, is to stabilise the material in the area of the design by means of a backing board, made for example of cardboard. The backing board is stuck to the material on the reverse side to that of the design using a peelable adhesive. Once the design has been coloured in, the backing board is removed. Due to the stiffness of the backing board, the area can be held in place by fixing any part of the board. The backing board also prevents the material from shifting or stretching in the area being coloured in. However, a disadvantage of the backing board is that if it is folded prior to colouring in, the result tends to be uneven. The material in the area of the fold will often lift away from the backing board. Consequently if uneven results are to be avoided, the backing board must not be folded, resulting in a bulky product.

In accordance with the present invention, there is provided a garment, a region of which has on a first side a design for colouring-in, the said region of the garment having on the reverse side thereof a removable backing to hold the material of the garment in place while colouring-in is carried out, wherein the removable backing comprises a material that can be folded without creasing.

As the garment has a removable backing, the material in the area of the design is stabilised, and so colouring-in of the design is facilitated. The backing also provides a barrier that helps prevent colour being transferred through the material of the garment onto other parts of the garment when the garment is being coloured in, causing undesirable staining. However, unlike the prior art garments where the removable backing should not be folded, the garment can be folded to reduce its size without the disadvantage that when coloured in the result is uneven. Folding to a reduced size means that the garment takes up less space when stored, and is especially suitable for supply via mail-order.

In one advantageous alternative, the removable backing is a textile material. It has been found that textile materials are particularly suitable for folding without creasing, and are generally thinner than cardboard so take up less space. Textile materials may be for example woven material, knitted material or felt. Textile materials includes cotton, silk, wool and synthetic materials. It has also been found that a removable backing made of a textile material, as opposed to a stiffer material such as cardboard, allows the material of the garment a small amount of movement in the area where the design is coloured in. This allows a greater degree of saturation of colour into the material of the garment, facilitating the colouring-in. Further, a textile material will soak up any excess dye that is produced while the design is being coloured in, helping prevent any undesirable migration of the dye in the material of the T-shirt.

Preferably, the removable backing is attached to the garment by means of a peelable adhesive. This makes the removable backing easy to remove. Alternatively, other adhesives that allow the removable backing to be removed could be used, for example adhesives that lose their adhesive properties when heated (for example when ironed), or that dissolve in water. Advantageously, a first portion of the removable backing is attached using a first adhesive and a second portion of the removable backing attached using a second adhesive, and the first adhesive is stronger than the second adhesive. The stronger adhesive prevents the removable backing from separating from the garment accidentally, while the use of the weaker adhesive allows the removable backing to be separated from the garment more easily. Advantageously, the first portion of the removable backing surrounds the second portion of the removable backing. This prevents the removable backing becoming separated from the garment where it is attached by the weaker adhesive, particularly in situations where the garment will be taken on and off multiple times, for example when being tried on in a shop. Advantageously, the removable backing is arranged such that when the backing is removed, the adhesive stays on the backing. This means that the garment can be worn immediately after the removable backing has been removed, and avoids the need to clean the adhesive off the garment.

Advantageously, the removable backing includes a tab. This facilitates the removal of the removable backing.

Advantageously, the removable backing is made of woven cotton. It has been found that woven cotton is particularly resistant to creasing. Cotton is also more suitable than many synthetic materials when the design is coloured in using dyes that are fixed using heat, for example by ironing, as synthetic materials often have a low melting point. Having a removable backing made of a synthetic material could melt when ironed, which could spoil the garment, pose a possible fire risk and pose a risk of skin burns.

Advantageously, the garment comprises a knitted material, and the removable backing is oriented with respect to the garment so that the warp or weft of the removable backing is parallel with the knit direction of the garment. This reduces the movement of the material of the garment when colouring in, as the woven material has least elasticity in a direction parallel to its warp or weft, while a knitted material has greatest elasticity in a direction parallel to the knit.

Advantageously, the removable backing is oriented with respect to the garment so that the direction of least elasticity of the removable backing is parallel to the direction of greatest elasticity of the T-shirt material. Again, this reduces the movement of the material of the garment when colouring in.

Advantageously, the backing further comprises a waterproof film. The waterproof film further improves the ability of the removable backing to provide a barrier that prevents colour being transferred through the material of the garment onto other parts of the garment when the garment is being coloured in.

In a second advantageous alternative, the removable backing is a paste material. A paste material is particularly easy to apply, especially for designs that are unusual or of a complicated shape. Preferably, the paste material is water-soluble. This allows the removable backing to be removed by soaking the garment in water, for example by washing it using a washing machine. Advantageously, the backing comprises a plurality of non-contiguous areas of paste material. This reduces the amount of paste material needed, and gives a more flexible backing. Preferably, the paste material comprises polyvinyl acetate. This has been found to give a particularly suitable backing, and is also water soluble, cheap, easily available, non-toxic and rarely causes allergic reactions.

Preferably, for both alternatives, the portion of the garment covered by the removable backing contains the portion of the garment covered by the design. The garment may comprise a plurality of designs for colouring-in, each design having a separate respective removable backing.

In a third advantageous alternative, the portion of the garment covered by the removable backing is a panel of the garment. A panel of a garment is a part of the garment that consists of a single piece of material, for example the front portion of a T-shirt. This means the portion of the garment with the removable backing can be made from material which already includes the removable backing, facilitating its construction. Advantageously, the portion of the garment covered by the removable backing is the entire garment. This allows the entire garment to be made from material which already includes the removable backing.

The design for colouring-in may be a screen print. Other methods of providing the design may be used, for example painting or stitching the design or by a transfer.

The garment may be a T-shirt. The invention is also suitable for other garments, such as shirts, trousers, underwear or hats. The garment may be made of a knitted material, or may for example be made of a woven material or felt.

In accordance with the invention there is further provided a method of manufacturing a garment of the first advantageous alternative described above, wherein the textile removable backing is brushed to lift the fibres of the textile prior to attaching the removable backing to the garment. The lifting of fibres makes the adhesive stick to the removable backing more effectively. Advantageously, the textile removable backing is attached to the garment by means of a spray adhesive sprayed on the backing after it has been brushed.

In accordance with the invention there is further provided a method of manufacturing a garment of the second advantageous alternative described above, wherein the paste material is applied to the garment through a stencil. This provides a simple method of applying the paste material over a particular area, particular for designs that are unusual or of a complicated shape. Advantageously, the opening in the stencil comprises a plurality of non-contiguous areas. This allows a thinner layer of paste to be applied, and also allows a backing comprises a plurality of non-contiguous areas of paste material to be easily formed. The paste material may be applied using a brush. Alternatively, the paste material may be applied using a spreader. Alternatively, the paste material is sprayed onto the garment.

In accordance with the invention there is further provided a method of manufacturing a garment as described above, comprising the steps of: providing a composite material comprising a first material and a removable backing; detaching at least one portion of the composite material; and constructing the garment from the at least one portion. This means a garment with the removable backing can be made from material which already includes the removable backing, facilitating its construction. The providing step may further comprise the sub-step of: attaching the removable backing to the first material using an adhesive. The attaching step may comprise the sub-steps of: spraying the adhesive onto the removable backing; pressing the first material and removable backing together between rollers. Advantageously, the attaching step further comprises the sub-step of: brushing the removable backing to lift its fibres; prior to spraying the adhesive onto the removable backing. This is particularly advantageous if a non-water-soluble adhesive is being used, as the adhesive is then removed when the backing is removed. If such an adhesive is sprayed on the first material, it will persist after the backing has been removed, changing the feel of the fabric and possibly causing irritation of the skin. Such an adhesive may persist even after the T-shirt has been washed a number of times. Alternatively, the removable backing is water soluble, and the providing step comprises the sub-step of: dampening the removable backing using water. This causes the removable backing to partially dissolve, causing it to stick to the first material. Preferably, the water is sprayed onto the removable backing. Advantageously, the removable backing comprises polyvinyl acetate. The providing step may further comprise the sub-step of: pressing the first material and removable backing together between rollers. The removable backing may be a water soluble material designed to approximate the feel of fabric.

In accordance with the invention there is further provided a method of colouring-in a garment as described above, comprising the steps of: colouring in the design using a heat-fixable dye, fixing the dye, and removing the removable backing. The dye may be fixed by means of an iron. The removable backing may be removed prior to the step of fixing the dye. Alternatively, the dye is fixed prior to the step of removing the removable backing.

Instead of using a heat-fixable dye, the garment could be coloured in using a washable dye, if it was not essential that the colouring-in survive the washing of the garment.

There will now be described embodiments of the invention, with reference to the accompanying drawings of which:

FIG. 1 shows a prior-art T-shirt;

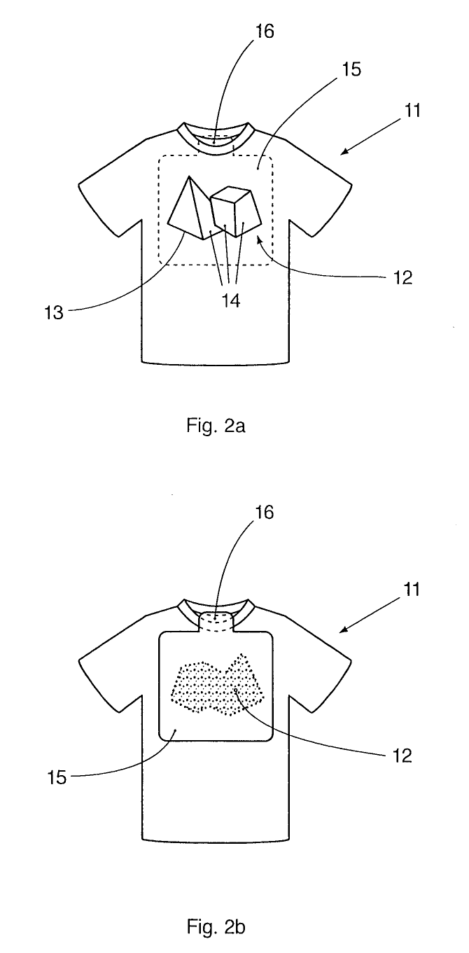

FIG. 2a shows a T-shirt according to a first embodiment of the invention;

FIG. 2b shows the T-shirt of FIG. 2a turned inside-out;

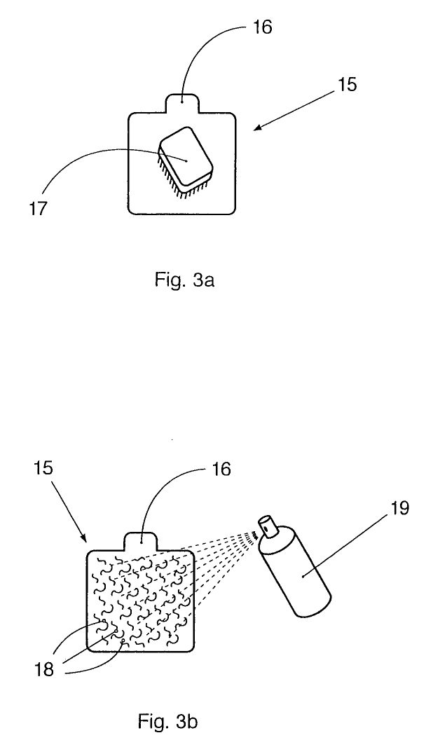

FIG. 3a shows a first step of a method of preparing the removable backing for the T-shirt of the first embodiment;

FIG. 3b shows a second step of a method of preparing the removable backing for the T-shirt of the first embodiment;

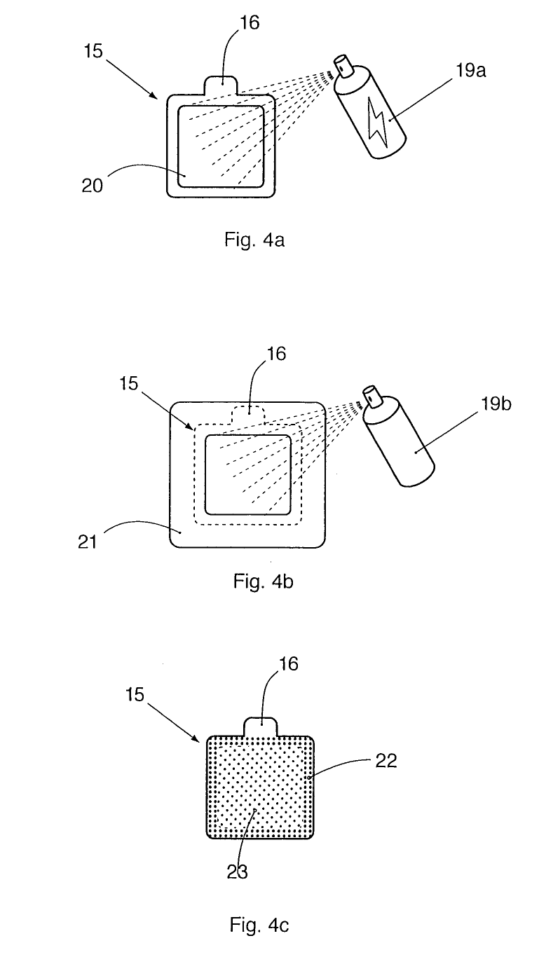

FIG. 4a shows a first sub-step of an alternative second step of preparing the removable backing for the T-shirt of the first embodiment;

FIG. 4b shows a second sub-step of the alternative second step of preparing the removable backing for the T-shirt of the first embodiment;

FIG. 4c shows a third sub-step of the alternative second step of preparing the removable backing for the T-shirt of the first embodiment;

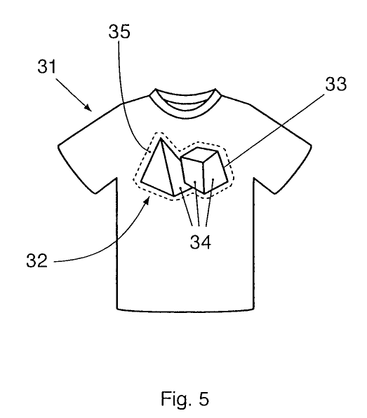

FIG. 5 shows a T-shirt according to a second embodiment of the invention;

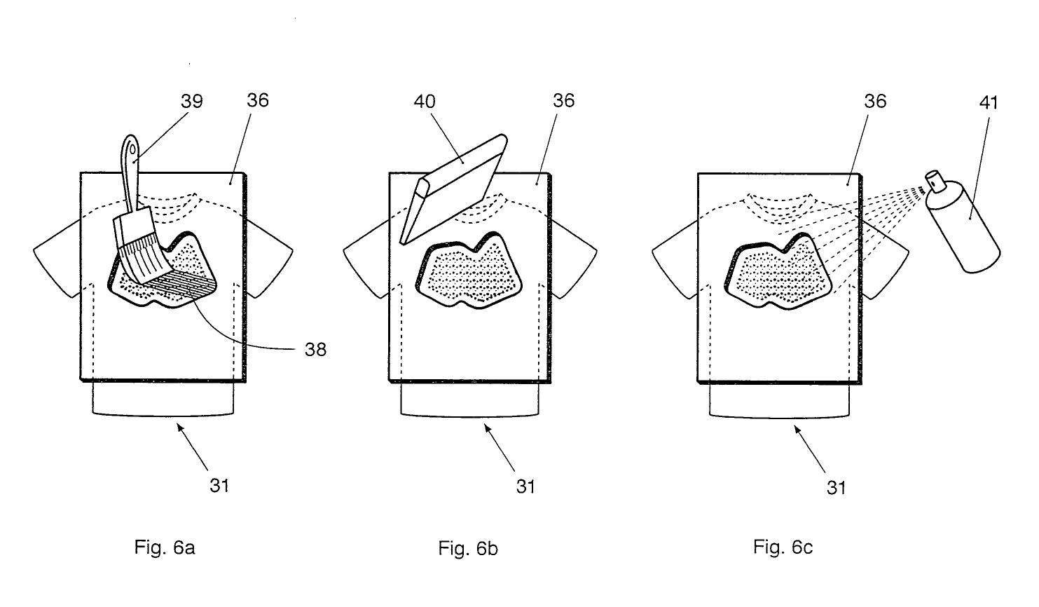

FIG. 6a shows a method of preparing the removable backing for the T-shirt of the second embodiment;

FIG. 6b shows an alternative method of preparing the removable backing for the T-shirt of the second embodiment;

FIG. 6c shows a further alternative method of preparing the removable backing for the T-shirt of the second embodiment;

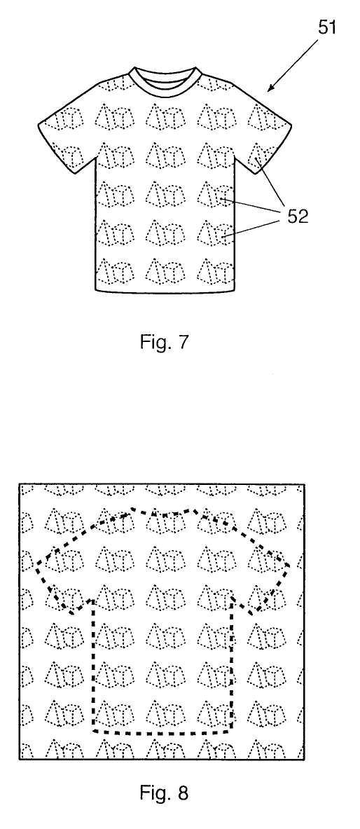

FIG. 7 shows a T-shirt according to a third embodiment of the invention;

FIG. 8 shows a piece of material from which the T-shirt according to the third embodiment is constructed;

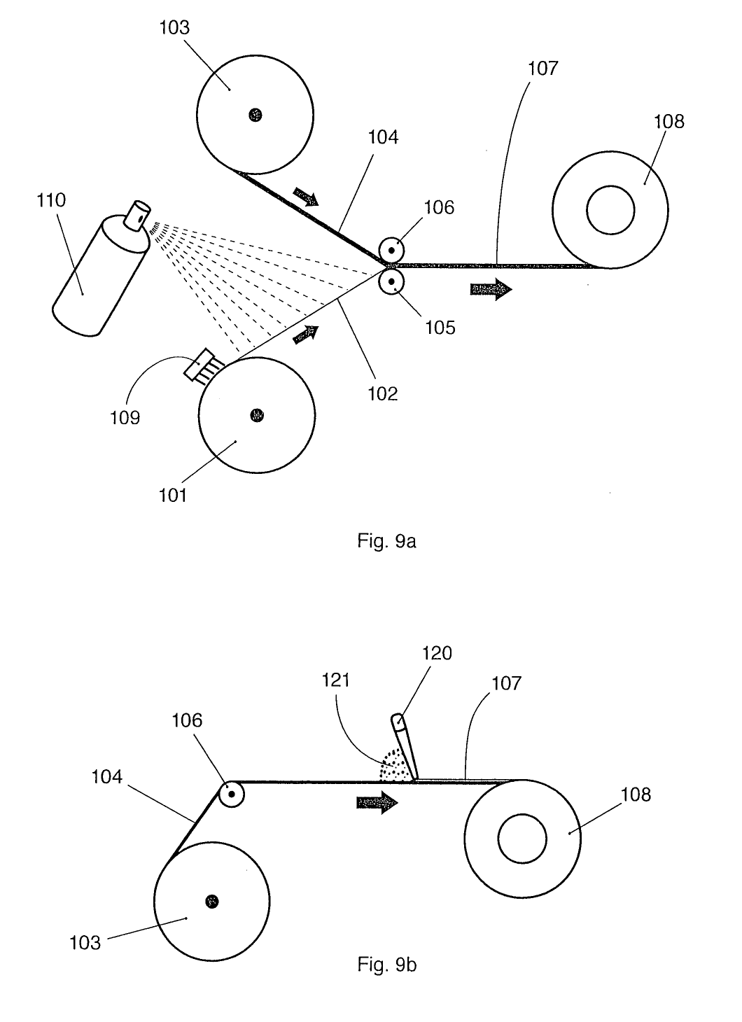

FIG. 9a shows a method of preparing the material of FIG. 8;

FIG. 9b shows an alternative method of preparing the material of FIG. 8.

A garment in accordance with a first embodiment of the invention is shown in FIGS. 2a to 4c. FIG. 2 shows a T-shirt 11 comprising a screen-printed design 12 consisting of an outline 13 defining a number of areas 14.

As shown in FIG. 2b, on the reverse side of the T-shirt 11 from the design 12, covering the area of the T-shirt encompassed by the design 12, is a removable backing 15 made of woven cotton material. The removable backing 15 is attached to the T-shirt by means of a peelable adhesive (that is, an adhesive that holds the removable backing 15 in place, but that is weak enough to allow the removable backing 15 to be removed from the T-shirt by peeling it off.) The removable backing 15 has a tab 16, not stuck to the material of the T-shirt 11, to facilitate the peeling off of the removable backing 15. The removable backing 15 is positioned so that the warp of the cotton of the removable backing is parallel to the knit direction of the T-shirt material 11. (The “warp” of a woven material is the set of threads that, when the material is made, are attached to the loom before weaving begins; the thread that is passed back and forth during weaving is known as the “weft”. A knitted material comprises horizontal rows consisting of a single continuous thread, which form stitches that interlock with the rows above and below to form vertical “ribs”. The horizontal direction of the rows is known as the “knit direction” of the material.)

The preparation of the removable backing 15 is shown in FIGS. 3a and 3b. As shown in FIG. 3a, first the removable backing 15 is brushed with a brush 17, to make the fibres 18 (shown in FIG. 3b) in the thread of the removable backing 15 stand up. As shown in FIG. 3b, the removable backing 15 is then sprayed with an adhesive 19. The adhesive is a resin carried and thinned by acetone; once the adhesive has been sprayed onto the backing 15 the acetone quickly evaporates leaving only the resin. However, any other suitable adhesive could be used. The removable backing 15 is then attached to T-shirt in the orientation described above.

In an alternative method of preparation of the removable backing 15, after the removable backing has been brushed as shown in FIG. 3a, the adhesive is applied as shown in FIGS. 4a to 4c. First, as shown in FIG. 4a, a first stencil 20 is put over the central part of the removable backing 15. A first adhesive 19a is then sprayed over the perimeter of the removable backing 15 that is not covered by the first stencil 20. (The tab 16 is not sprayed with adhesive, and to enable that is folded behind the backing while it is being sprayed, or alternatively covered by a further stencil.) The stencil 20 is then removed, and, as shown in FIG. 4b, a second stencil 21, which leaves uncovered only the central part of the removable backing 15 covered by the first stencil 20, is put over the removable backing 15. A second, weaker adhesive 19b is then sprayed over the central portion of the removable backing 15 not covered by the second stencil 21. As shown in FIG. 4c, the resulting removable backing 15 has a perimeter area 22 covered with the stronger adhesive 19a, and a central area 23 covered with the weaker adhesive 19b. As before, the removable backing 15 is then attached to T-shirt in the orientation described above.

Although the woven cotton removable backing has been described as being oriented so that the warp of the cotton is parallel to the knit direction of the T-shirt material, the removable backing will provide a useful amount of stabilisation when oriented in any direction. In general, the best stabilisation will be achieved when the direction of least elasticity of the removable backing is parallel to the direction of greatest elasticity of the T-shirt material.

A garment in accordance with a second embodiment of the invention is shown in FIGS. 5 to 6c. FIG. 5 shows a T-shirt 31 comprising a design 32 consisting of an outline 33 defining a number of areas 34, as in the first embodiment. On the reverse side of the T-shirt 31 from the design 32, covering the area of the T-shirt encompassed by the design 32, is a removable backing 35 made from polyvinyl acetate (PVA). As PVA is water-soluble, when a user has finished colouring-in the design and wishes to remove the backing, they can do so by soaking the T-shirt in water, for example by washing the T-shirt in a washing machine, thus dissolving the PVA.

Three possible methods of applying the paste material to form the removable backing are shown in FIGS. 6a to 6c. In the first method, as shown in FIG. 6a, the T-shirt 31 is turned inside-out, and a stencil 36 is placed over the T-shirt. The hole in the stencil is shaped so as to leave uncovered the area on the reverse side of the T-shirt surrounding the design 32. The PVA 38, which has been diluted with water, is then applied to the T-shirt using a brush 39, and allowed to dry. The second method, as shown in FIG. 6b, is similar, except that a spreader 40 is used to apply the paste to the T-shirt. In the third method, as shown in FIG. 6c, the PVA is sprayed onto the T-shirt using a spray device 41.

The removable backing formed from PVA will generally be stiffer than that formed from woven cotton as described in the first embodiment. In order to provide a more flexible removable backing, a stencil with a “criss-cross” pattern can be used, which gives a less dense layer of PVA. A criss-cross stencil can also be used to give a backing formed of many small unconnected areas of PVA.

A garment in accordance with a third embodiment of the invention is shown in FIGS. 7 to 9b. FIG. 7 shows a T-shirt 51 comprising a number of designs 52, the designs consisting of an outline defining a number of areas, each design being similar to the single designs described in the first two embodiments. The T-shirt is made of a composite material comprising a knitted material fused to a soluble backing material. A soluble backing that is designed to approximate the feel of fabric could for example be used. Once the design has been coloured in, the T-shirt is for example washed using a washing machine, thus dissolving the backing.

As shown in FIG. 8, the composite material from which the T-shirt is made comprises the knitted material fused to the soluble backing, rather than the backing material being added to the knitted material after the T-shirt has been constructed. It should be noted that it is necessary to increase the tension of the stitching of the T-shirt when it is being constructed, so that they the stitches have the correct tension when the backing has been removed.

Methods of making the composite material are shown in FIGS. 9a and 9b. In the first method, as shown in FIG. 9a, backing material 102 from a roll 101 and knitted material 104 from a roll 103 are fed between a pair of pressure rollers 105 and 106, which press the materials together to form the composite material 107. The composite material in then rolled onto a roll 108. The diameter of the roll 108 is great enough that the composite material does not become excessively curved, which would complicate the construction of the T-shirt. As the backing material 102 travels between the roll 101 and the pressure rollers 105 and 106 it is brushed by a brush 109, which lifts the fibres of the material, and then sprayed with an adhesive 110. The lifted fibres of the backing material facilitate the grip of the adhesive.

Instead of adhesive, warm water can be sprayed on the knitted material 104 or backing material 102. The warm water partially dissolves the backing material 102, causing it to stick to the knitted material 104. Different amounts of water can be sprayed onto different parts of the backing material, so that the backing material is stuck to the knitted material with different strengths in different places.

In the second method, as shown in FIG. 9b, knitted material 104 from a roll 103 is fed over a roller 106, and onto a roll 108. Between the roller 106 and the roll 108, a “floating knife” 120 spreads soluble paste material 121 onto the knitted material. The soluble paste material is as described in the second embodiment above. The paste can be distributed in different amounts on different parts of the backing material, in order to make it more flexible.

In each of the above methods, the combined material 107 can be heated to dry it before it is rolled onto the roller 108.

It is described above that the backing may comprise a waterproof film to improve the ability of the removable backing to provide a barrier that prevents colour being transferred through the material of the garment onto other parts of the garment when the garment is being coloured in. A suitable film may be made from “plastisol” type inks; plastisol inks usually comprise a mixture of a PVC resin (as a white powder) and a plasticizer (as a thick, clear liquid), and are cured by heating. The plastisol inks can be applied using standard screen-printing techniques.

1.-41. (canceled)

42. A garment comprising: a region having on a first side a design for coloring-in, the said region of the garment having on the reverse side thereof a removable backing to hold the material of the garment in place while coloring-in is carried out, wherein the removable backing comprises a material that can be folded without creasing.

43. A garment as claimed in claim 42, wherein the removable backing is a textile material.

44. A garment as claimed in claim 42, wherein the removable backing is attached to the garment by a peelable adhesive, a first portion of the removable backing is attached using a first adhesive and a second portion of the removable backing attached using a second adhesive, the first adhesive is stronger than the second adhesive, and wherein the first portion of the removable backing surrounds the second portion of the removable backing.

45. A garment as claimed in claim 43, wherein the removable backing is made of woven cotton, the garment comprises a knitted material, and the removable backing is oriented with respect to the garment so that a warp or weft of the removable backing is parallel with a knit direction of the garment.

46. A garment as claimed in claim 43, wherein the backing further comprises a waterproof film.

47. A garment as claimed in claim 42, wherein the removable backing is a paste material.

48. A garment as claimed in claim 47, wherein the paste material is water-soluble.

49. A garment as claimed in claim 47, wherein the backing comprises a plurality of non-contiguous areas of paste material.

50. A method of manufacturing a garment as claimed in claim 43, wherein the textile removable backing is brushed to lift fibres of the textile prior to attaching the removable backing to the garment.

51. A method as claimed in claim 50, wherein the textile removable backing is attached to the garment by a spray adhesive sprayed on the backing after it has been brushed.

52. A method of manufacturing a garment as claimed in claim 47, wherein the paste material is applied to the garment through a stencil.

53. A method as claimed in claim 52, wherein the stencil defines an opening having a plurality of non-contiguous areas.
